(19) United States
(12) Patent Application Publication
(10) Pub. No.: US 2006/0045473 A1
(43) Pub. Date: Mar. 2, 2006

(54) Method and apparatus for storing and accessing videos

(76) Inventor: Eric Alterman, Jupiter, FL (US)

Correspondence Address: Baker & Hostetler LLP;Washington Square, Suite 1100, 1050 Connecticut Avenue, N.W., Washington, DC, 20036, US

(21) Appl. No.: 10/974,701

(22) Filed: Oct. 28, 2004

Related U.S. Application Data
(63) Continuation-in-part of application No. 10/928,750, filed on Aug. 30, 2004.

(51) Int. Cl. H04N 5/783

(52) U.S. Cl. 386/69; 386/70

(57) ABSTRACT

A method and apparatus that includes a central repository for a plurality of videos, which are associated with a category. Once the video is uploaded or stored at the central repository, it is reviewed to determine whether what type of access, if any, should associated with the video. A tracking device can be used to determine the number of requests that are made for he video or how many times the video has been viewed. The central repository is available through a remote access point, which enables the videos to be access from almost any location.

This application is a Continuation-In-Part to U.S. patent application entitled “METHOD AND APPARATUS FOR STORING AND ACCESSING VIDEOS,” filed Aug. 30, 2004, having a Ser. No. 10/928,750, the disclosure of which is hereby incorporated by reference in its entirety.

### FIELD OF THE INVENTION

The present invention relates generally to videography. More particularly, the present invention relates to storing and accessing videos through a common database structure such that they are organized in a logical manner and made available to anyone who has access to the database.

### BACKGROUND OF THE INVENTION

Modern video technology has made it easier for both professionals and amateurs to create their own videos. Additionally, the digital format of these videos has enabled these individuals to more easily transport and share these creations by merely transporting the digital content to the intended user.

Many times, however, these individuals wish to share their creations on a larger scale such as the general public. Previously, these individuals would create a medium or method by which they would make these videos available. These mediums could be video stores or specialty merchandise shops that would carry niche goods. The disadvantage with this method is that it is both expensive and not very effective. Many stores are reluctant to carry niche videos because of a perceived lack of demand and shelf space required.

With the advent of the Internet, these videos can be made available on a videographer's website. Though more easily available than the previous technique, this method has a disadvantage in that the website is usually hard to locate among the many thousands and thousands of websites.

Using a search engine to locate a specific video topic, usually results in multiple possibilities. The average web user usually only reviews the first couple pages of results generated by the search engine. If the desired video is in the middle or the end of the results, then it is unlikely to be uncovered or viewed.

Accordingly, there is a need for a method and apparatus for videographers to easily share their niche video product with a public looking to view and discuss specific video works.

### SUMMARY OF THE INVENTION

The foregoing needs are met, to a great extent, by the present invention, wherein in one aspect an apparatus is provided that in some embodiments include a central repository such as a database, where a number of videos are located and made available to be accessed. Videos, in the preferred embodiment, are uploaded to central repository and await approval. Upon approval, the videos are associated with a particular category and made available through an access point, which can be entered through a remote location.

In accordance with one embodiment of the present invention, a repository for accessing and storing videos includes a storage device, a plurality of categories, wherein a category is associated with a video that is located on the storage device, an uploader configured to permit the video to be transmitted to the storage device and an approver device configured to either reject or accept the video.

If the approver device accepts the video, then access is permitted to the video. If the approver device does not accept the video, then access to the video is not immediately granted. By allowing access to the video, the video can be downloaded or viewed through an access point, which can be done remotely. The preferred embodiment links the central repository to a computer network such that it can be accessed remotely.

In accordance with another embodiment of the present invention, a method for accessing and storing videos includes reviewing a video linked to a central repository, determining whether to accept the video, associating a category with the video and in response to accepting the video, permitting access to the video. Further elements to this embodiment may include uploading the video to the central repository and being able to search through the videos on the central repository by analyzing the categories, which are associated with the videos.

In this embodiment, the central repository can be accessed through a remote access point, which is linked to a computer network such as local area and wide area networks. In this embodiment, the network is the Internet. To access the video, in this embodiment, a user or accessor logs in to a previously registered account.

In this embodiment, a forum such as a bulletin board, as well as a page with personal information is generated for each videogrpaher when he registers/creates his account. This area serves as a location for viewers of the video to ascertain information on the videographer and their works.

In accordance with yet another embodiment of the present invention, a system for accessing and storing videos includes means for reviewing a video linked to a means for storing, means for determining whether to accept the video, means for associating a category with the video and in response to accepting the video and means for permitting access to the video. Further elements to this alternate embodiment can include means for uploading the video to the means for storing, means for searching a plurality of categories, which are associated with a plurality of videos and means for accessing the video through a remote access means.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustration of a central repository according to a preferred embodiment of the invention.

FIG. 2 is an illustration of one aspect of the account option according to the preferred embodiment of the invention.

FIG. 3 is an illustration of yet another aspect of the account feature according to the preferred embodiment of the invention.

FIG. 4 is an illustration of the video upload feature according to the preferred embodiment of the invention.

FIG. 5 is an illustration of the video viewing feature according to the preferred embodiment of the invention.

FIG. 6 is an illustration of the video approval feature according to the preferred embodiment of the invention.

FIG. 7 is an illustration of yet another alternate embodiment of the present invention.

### DETAILED DESCRIPTION

The invention will now be described with reference to the drawing figures, in which like reference numerals refer to like parts throughout. An embodiment in accordance with the present invention provides a central repository for a plurality of videos, which can be uploaded or even downloaded from the central repository. For videos that are uploaded, the video is placed into an approval queue. The video is viewed and accepted or rejected based upon a review of the video. If the video is rejected, access is not permitted or substantially limited. The central repository includes a search feature that enables one to search the video through attribute associations such as categories. The benefit of the central repository is that it is a single location, where an individual can go to upload or download a video from almost any location.

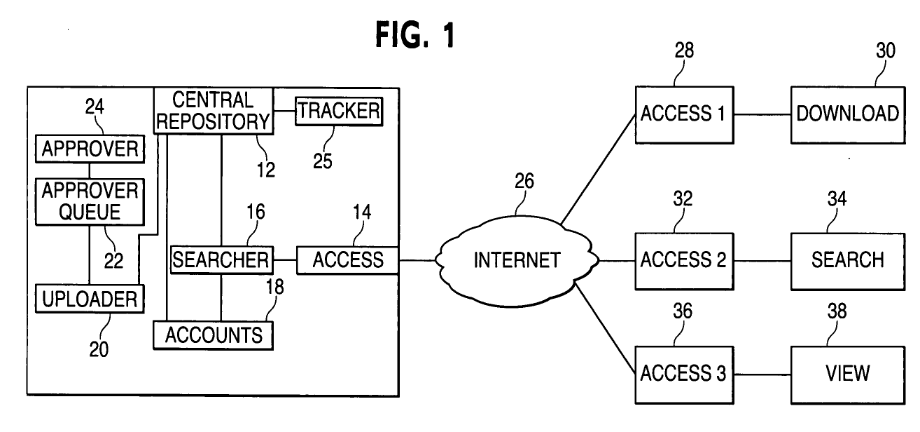

An embodiment of the present inventive apparatus and method is illustrated in FIG. 1. FIG. 1 is an illustration of a central repository and how it is linked to both local and remote users. The present invention is a system 10 that includes a number of different components working together to permit users to access, retrieve and store data at a central location. The system 10 includes a central repository 12, where the videos are stored or located. The preferred embodiment uses a central database to store the videos. Alternate embodiments can use a number of different databases or storage units to store the items such that these devices are all linked to a central location.

To get access to the videos on the central repository 12, an access point 14 is provided for the user. The access point 12 is a communications port that enables access from almost any location. The access point 12, in the preferred embodiment, is compatible with TCP/IP protocol and thus allows connections via computer networks such as the Internet. Alternate embodiments of the present invention permit access to other types of computer networks as well.

The access point 12, in the preferred embodiment, can be reached by knowing its uniform resource locator (URL) such as http://www.knowitallvideo.com. By requesting access to the URL, a user is directed to the system 10.

Upon reaching the URL, a user is provided with a website that contains a plurality of data such as textual information concerning the service provided and a searcher 16. The searcher 16 is a tool that enables a user to discern which videos were stored or linked to the central repository 12. In the preferred embodiment, the searcher 16 contains a number of levels that help the user sort through a number of videos. The first level is a category level. The category level can be general or as specific as desired. For example, a video on gardening could initially be under the category home improvement. Once the category is selected, the searcher 16 responds with different categories such as landscaping, interior decorating, additions and so on. The user would then have to select landscaping, which can contain a further number of levels.

Each subcategory and subsubcategory existing in the system 10 includes its own bulletin board, which serves primarily as a discussion forum for viewers of the videos to enter their comments about videos associated with the particular category. This area would be used by potential viewers as a possible means to determine which videos among a particular category to view. The comments posted by previous users would be viewed by the potential viewers in order to aid them in the selection. The comments could also be directed to express a need for a particular type of video within the category.

The searcher 16 of the present invention also is able to provide an alphabetical listing of the videos on the central repository 12 as well as a keyword search. All the various search functions of the searcher 16 provide the user a multitude of options in order to find a video that is most applicable to their needs such as author, highest rated, most watched, most recent and by category.

In the preferred embodiment, upon gaining entry to the system 19 through the access point 14, an account option 18 is provided for the user. The account option 18, in the preferred embodiment, requires that any user, who wants to download and upload a movie, create an account with the account option 18. In this embodiment, it is not necessary for a user to sign into their account in order to use the searcher 16.

The account option 18 is more or less used as a system to keep track of the videos and the users. As is detailed in greater below, the account option 18 collects some minimal information in order to keep track of a user. The information can be login name, e-mail and residential address.

The account option 18 is linked to a database that could literally store thousands upon thousands of subscribers to the system 10. The database can be part of the central repository 12 or a separate database all together.

If a user desires to upload or transmit a movie to the central repository 12, then an uploader 20 is provided for such a task. The uploader 20, once the user has logged into their account via the account option 18, alerts the system 10 that a video is being transmitted. Prior to uploading and in response to a request to upload, the system 10 determines which attributes to associate with the video. The attributes can be the video category, the date and time, the user and any text provided.

In response to a request to upload and upon transmission of the video from the user, the system stores the received video in an approval queue 22. The system 10, in the preferred embodiment, does not permit access to a video unless it has been through an approval process and given the requisite permission by an approver 24.

The approval queue 22 is an area that stores or holds the videos transmitted through the uploader 20. The approver 24 then retrieves a video from the approval queue 22 in order to determine whether to grant its approval. In the preferred embodiment, the approver 24 is an option granted to an administrator. Upon viewing a video, the video is then associated with an accepted or rejected attribute. If the video is accepted, then the access is granted to the video. If the video is rejected, then access is not granted or substantially limited.

If the video is accepted, then it is placed into the category/categories designated by the user, or the administrator, and made available to the searcher 16. At this point, the video is available for access on the central repository 12.

Videographer discussion boards and personal pages are created when the videographer creates an account. The discussion board is able to be accessed by viewers and those individuals, accessors, perusing the system 10. The discussion board serves as a forum where any of the viewers of the videographer's videos can enter their comments or remarks about one or more specific videos. For the accessors, it could serve as a basis for possible viewing the works created by the videogrpaher. The comments could be reviewed by the accessor prior viewing the video works to determine if they would be interested in the videogrpaher. While for the viewers, it would most likely serve as a forum to discuss the positives and negatives of the videographer and their works.

If the video is not accepted, the approver 24 generates a letter that is sent to the user informing them of the decision to reject. The letter can be a standard rejection stating that it did not fall within the guidelines of the system or it could be more specific as to why it was rejected.

In alternate embodiments, the approver 24 contains an electronic checklist that includes a number of either specific or general entries that can be checked as to why a video is rejected. The approver 24 can also contain an area where text comments are entered. Upon completion of the rejection, the letter is automatically populated with the checked items and/or text comments. The preferred embodiment sends an e-mail, provided by the user when registering an account, that the video has been rejected.

The system 10 also includes a tracker 25. The purpose of the tracker 25 is to keep an account of how many times the video has been accessed or viewed. This data, in the preferred embodiment, is displayed for a user of the system as well for the individual who uploaded the video to the system 10. The data acts as a gauge for the viewer or videographer as to the potential or actual interest in the movie. For example, if there are a significant number of requests for accesses to the video but little corresponding viewing of the film, then there could be a potential problem with the description of the video that is provided for a potential user.

As explained, the system 10, through the access point 14, is linked to the Internet. The Internet 26 enables almost any number of users to access the system 10 from any location as long as there is access to the Internet 26. For example, a user 28 might wish to download 30 a video after they have just perused the system 10. Simultaneously, there might be a second user 32 that is using the system 10 and the searcher 16 to search 34 through the video inventory. The second user 32 might just be looking generally or for a specific item. Additionally, there might be a third user 36 that is in the process of viewing 38 a video online without the need to download it.

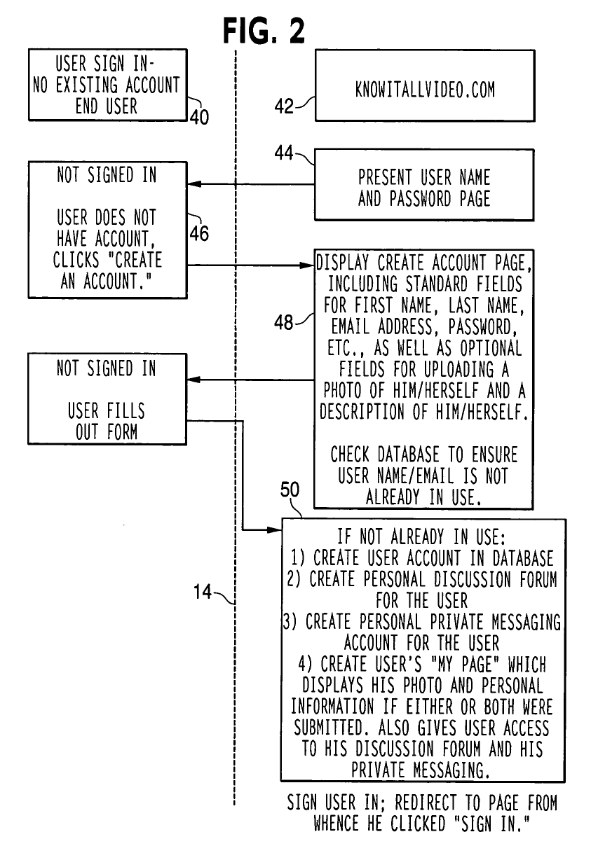

FIG. 2 is an illustration of one aspect of the account option according to the preferred embodiment of the invention. As discussed previously, the account option 18 provides a means by which a user is able to upload and download videos from the central repository 12 through the access point 14. In FIG. 2, the figure is divided into two sections, an end user section 40 and the system side 42.

The system side 42, with the related account option 18, is presented to the user either upon initial access to the system 10 or upon a request to access video associated with the central repository 12. In these events, the end user is presented with the account login screen 44, which requests the user to enter their user name and password. The system 10 responds with a message 46 that the present user is not signed in. There is an option on this page for those users that do not have an account, to create an account. If a non-account holder chooses the non-account option, then the user is presented with a new account form. The new account form 48 includes standard fields for first name, last name, e-mail address, password etc. In the preferred embodiment, the new account form 48 includes an option for uploading an image of the user as well as an area for providing a description of the user. The new account form 48 can be tailored or customized in any manner by the system 10.

Once all the information is collected from the user through the new account form 48, the system 10 checks its database for the user to ensure that the user name and/or e-mail is not already in use. If the user name and/or e-mail are not already in use, then an account is created through the account creation page 50. This step, in the preferred embodiment, creates a user account in the user database, creates a personal discussion forum for the use, creates a personal private messaging account for the user, and creates user's “My Page,” which displays his photo and personal information if either or both were submitted. The user is also given access to his discussion forum and his private messaging.

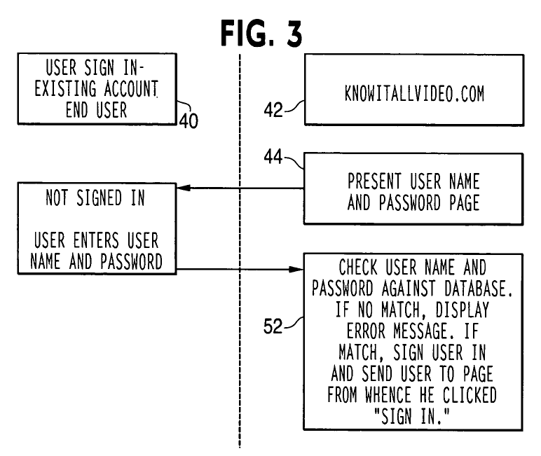

FIG. 3 is an illustration of yet another aspect of the account feature according to the preferred embodiment of the invention. FIG. 3 illustrates what a user with an account encounters each time it attempts to access the central repository 12. The user is presented with the account login screen 44, which requests a user name and the password. Upon entering the requisite information, the system uses a check step 52 to determine whether the entered information creates a match within its database. If there is a positive match, access is granted to the degree permitted by the system 10 upon setting up an account. Additionally, the user is returned to the position from where the user logged in. For example, if the user wanted to access a video on poker, then the user is returned to the movie and granted access to view or download the video. If there is not a positive match, then the system 10, through account database, returns an error message.

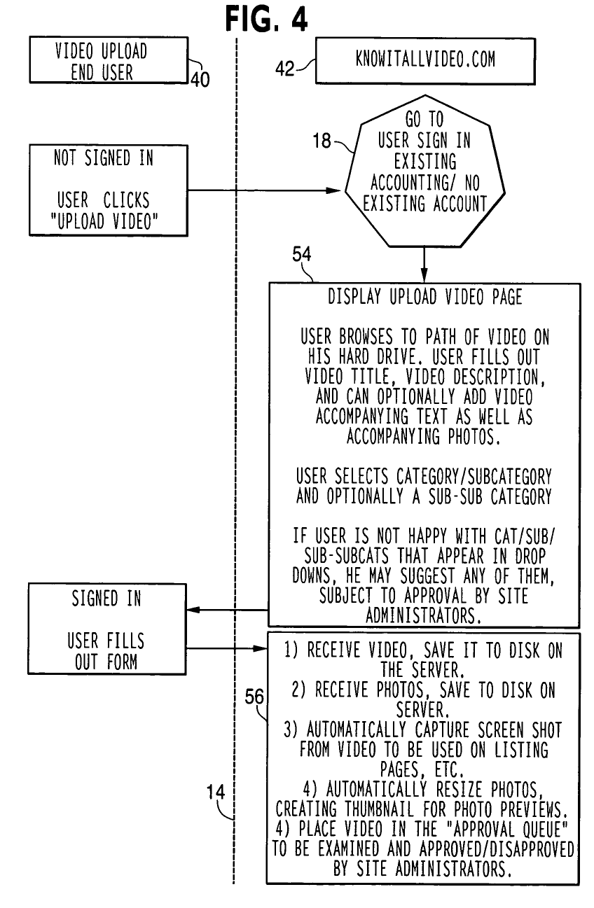

FIG. 4 is an illustration of the video upload feature according to the preferred embodiment of the invention. This figure details how a video is uploaded to the system 10. The user accesses the system 10 through the access point 14, which is generally accomplished through the Internet.

To upload the video to the system 10, the user must sign into their account through the account feature 18. If an account is not set up already, then the user would need to set up an account before proceeding.

Once the user is logged into the system 10, the user is presented with some options on how to proceed with the upload. One of the options is to direct the system 10 to where to find the video on the user's system through the display upload video option 54. For example, in the preferred embodiment, the present invention is implemented with a computer system. A user uses their computer to access the system 10. During the uploading procedure, a browse option is selected which directs the system 10 to where the video is residing on the user's storage unit, which, in the preferred embodiment, is a computer hard drive.

The display upload video option 54 also includes a list of categories from which the user can choose to associate the video. In alternate embodiments, there can also be subcategories. If the user is not happy with the categories or the subcategories that are present in the display upload video option 54, then the user may suggest a category or subcategory to the approver 24 or administrator.

In the alternate embodiments, the display upload video option 54 also includes options for a short preview of the video, accompanying text to include a short description of the video, ratings and other information that the user might think is useful or helpful to a potential viewer. Other possible options are contact information of the videographer or uploader and links or guides in order to obtain additional information.

After the display upload video option 54 is completed, the system 10 begins to receive, through the receive function 56, or accept the video from the user. The system 10 stores the video on the central repository 12. The system also stores any accompanying photos on the central repository 12. In the preferred embodiment, the photos are automatically resized, which creates essentially a thumbnail for photo previews. Furthermore, the video is placed in the approval queue 22, until it is approved or disapproved.

In the preferred embodiment, each time a video is uploaded to the system 10, it is placed in the approval queue 22. By placing it in this location, the access attributes to the video are strictly limited to the administrators. Once it is located in the approval queue 22, a message is sent to administrator informing them that a new video has been upload and available for review. Until the access attributes are changed, the video resides in the approval queue 22. Once it is approved, the access attributes are extended to those users that have created an account through the account option 18.

In the preferred embodiment, when a user creates an account, the system creates a home area or home page for that specific videographer. The home page includes a listing of all the videos submitted by the videographer, web links, photos, a discussion board and a message center. The home page is configurable by the videographer to include any other information desired.

The present invention also enables an account holder or user to publish their content through a Really Simple Syndication (RSS) service. By allowing this ability, the system 10 enables other sites to publish some of its content. To do this, the system 10 creates an RSS document and registers the document with an RSS publisher. A user, that can read RSS-distributed content, can use the content on a different site. Syndicated content includes such data as news feeds, events listings, news stories, headlines, project updates, excerpts from discussion forums or even corporate information.

Some of the search engines on the Internet today enable a user to add the RSS service to an individual that has a registered account. For example, a registered account holder for YAHOO!® could link their YAHOO!® account to the system 10 such that it activates the RSS service provided by YAHOO!®. Therefore, a user would be updated through the YAHOO!® account when new data or additions are added to the system 10. The data can be specific such as to a category or videogrpaher or generally such as to anything new updated to the system 10.

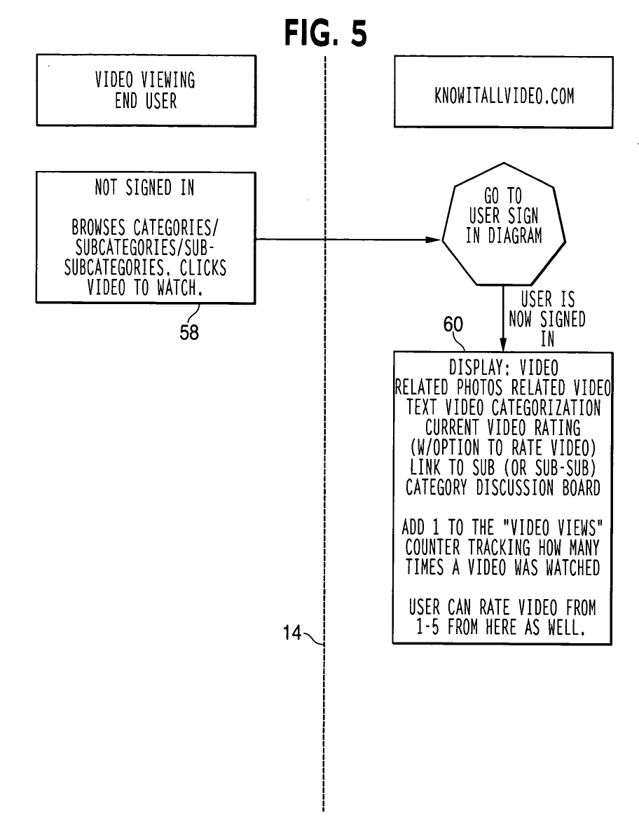

FIG. 5 is an illustration of the video viewing feature according to the preferred embodiment of the invention. In the preferred embodiment, a user is able to view a video through the access point 14. To do this, the user would access the requisite URL and then locate the video through the searcher 16. To view a video, the user would select the video and immediately be presented with the login option 58, which would require that the user enter in their user name and password. Verification is made against the entered data and the system account database. If the verification is positive, then the user is allowed access to the video through the display video option 60. In the preferred embodiment, the display video option 60 permits access to the video, related photos, related video text and the video associated category. If the user wants to continue and watch the video, the video is selected to be viewed.

The display video option 60, in alternate embodiment, can also include current video rating, which is made up of other users that have viewed the video and any related text. The rating is a number system such as 1 through 5 which is selected by the viewer. The system 10 tallies the rating and determines the overall average of the rating and displays it.

The preferred embodiment also includes a tracker 25 that keeps account of accessing and/or viewing of the video. In the preferred embodiment, a numerical number such as one (1) is added each time the video was viewed and a running tally is kept. In an alternate embodiment, the tracker 25 can also provide the view to hit ratio, which is a proportion of the number of actual views of the video to the number of requests to access.

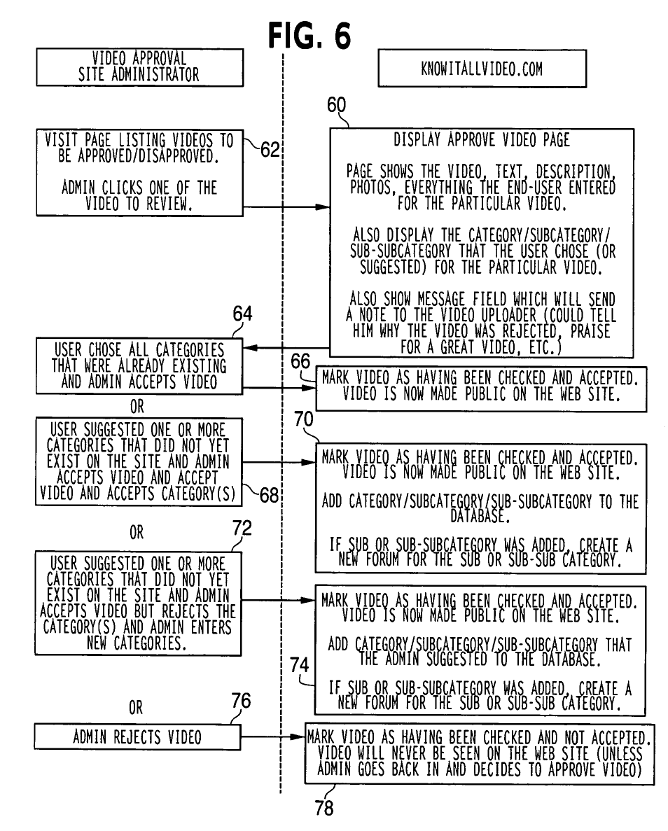

FIG. 6 is an illustration of the video approval feature according to the preferred embodiment of the invention. As previously detailed, each video, in the preferred embodiment, that is uploaded to the system 10 is passed through to the approver 24. The approver 24 generates a video listing, in the preferred embodiment, of all the upload movies that are waiting to be approved or disapproved. In the preferred embodiment, the administrator selects the movies to review and then either approves or disapproves the video. In alternate embodiments, the film approval or disapproval process can be accomplished automatically. One such example would be a script that would need to be submitted with the video. The script would then automatically be analyzed by the system to determine whether any of the video is not within the standards set out by the administrator. If the video is determined not to be within these standards, the video is not approved.

Upon selecting a video to view, the display video option 60 is made available to the site administrator. As discussed, the display video option 60 shows the video, text, description, photo and anything else the user entered when uploading the video to the system 10. The display video option 60 also includes the category and/or subcategory 64 that the user has chosen or suggested for the uploaded video. If the uploaded video is associated with an existing category and the video has been designated as accepted, then the video is publicly made available.

If the user suggested one or more categories 68 that did not exist, then the approver 24 has to determine whether to accept 68 the category suggested by the user. If the video has been analyzed and accepted, then public access is permitted to the video. Public access, if the account feature 18 is active, would be limited to those users that have obtained an account with the system 10.

After accepting the video, the approver 24 must determine if the proposed category 70 is to be accepted or added to the database. If the proposed category 70 or subcategory is accepted, then the system 10 automatically creates a new forum for the new category.

If the approver 24 accepts the video, but rejects 72 the new category, then the video category association is changed 74 by the approver to a new category. The changed 74 association can be accomplished in a number of different ways. In the preferred embodiment, the category is changed to an already existing category. Therefore, the administrator would select a category from the list of categories and link the video to it.

In an alternate embodiment, the same ability to change the association to an already existing category is available. Additionally though, the administrator can reject the suggested category and create a new category for the video. Therefore, the video will be linked to a newly created category that is different from the one suggested by the user.

If the approver 24 rejects 76 the video, then the video is marked as having been reviewed 78 but not accepted. Access on the system is not permitted for those other than the administrator. Note that it is possible for the administrator to restrict access to just themselves or a very limited number of users based upon the rejection. Full access is not permitted unless the administrator alters the rejection status to an approval status.

The present invention also enables users of the system 10 to share links to videos that might be of particular interest to other viewers. In the preferred embodiment, the user would select the video that they would like sent to another potential viewer of the video. Upon selection of the link, an e-mail is generated by the system 10 and sent to the potential viewer. In alternate embodiments, there can be location in the e-mail for comments by both system 10 and the user.

Additionally, the present invention enables a user to send a message to a videographer or user of the system 10 in order to send general comments or to request or inquire about specific items. In the preferred embodiment, the messaging is anonymous, which doesn't require the viewer to disclose themselves. By being anonymous, the viewer is more apt to be honest about critiquing the video or anything else about the videographer.

The preferred embodiment also contains a location where a user of the system 10 can request specific videos that are not yet available. This location is available to those users that have accounts with the system 10. At this location, the videographers are able to ascertain what particular demands or requests are being submitted by the requesters. The videographer can submit a video already covering this subject or begin to assembly one.

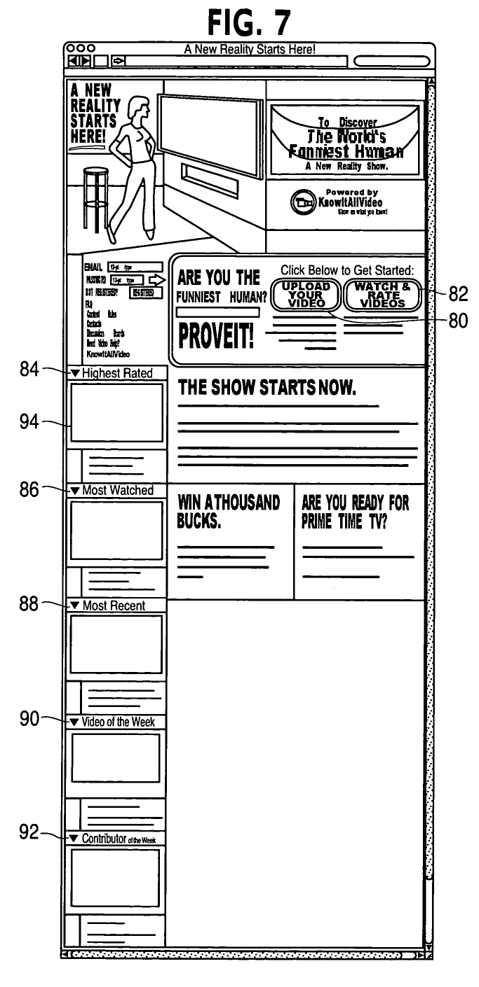

FIG. 7 is an illustration of yet another alternate embodiment of the present invention in which the present invention is used as an interactive tool for use with differing forms of media. Specifically, FIG. 7 illustrates the incorporation of the present invention with television media, specifically reality based television shows.

The present invention enables individuals to cast, submit or develop media concepts, such as reality based television shows, through an online process. As an example of casting in regards to reality based television shows, potential participants transfer or upload their video through the video upload button 80. Once these videos or snapshots are uploaded, the videos can be made available immediately for viewing or the uploads can be stored with the approval queue 22. If the videos are placed in the approval queue 22, the system 10, in the preferred embodiment, does not permit access to a video unless it has been through an approval process and given the requisite permission by an approver 24.

With this embodiment, the videographers are also able to submit concepts for potential media projects as well. These concepts can be for television shows such as sitcoms, drama, reality, and many others. These concepts are uploaded and made available such that companies are exposed to potential ideas that would or could be popular on television. These videos can also be used by the companies as a sense for the type of videos that the general public is interested in viewing.

In uploading the video, the individual or uploader is granted additional space such as a “My page” where additional information concerning the individual or video may be located. The additional information may include, but not limited to, screenshots accompanying photographs and text descriptions. Additionally, a discussion board is generated or created for each person that uploads a video as discussed in the previous embodiment.

Once the videos are uploaded and approved, they are placed or located in a specific category such as subcategories or subsubcategories. The videos can be placed in such categories as type of humor (category), stand-up (subcategory), political or many others. The person uploading the video can place the video in an already existing category or can suggest a new one. Upon approval of the video, the video can be reassigned to another category, the videogrpaher's assigned category or the new category.

If the user suggested one or more categories 68 that did not exist at the time of uploading, then the approver 24 has to determine whether to accept 68 the category suggested by the user. If the video has been analyzed and accepted, then public access is permitted to the video. Public access, if the account feature 18 is active, would be limited to those users that have obtained an account with the system 10.

After accepting the video, the approver 24 must determine if the proposed category 70 is to be accepted or added to the database. If the proposed category 70 or subcategory is accepted, then the system 10 automatically creates a new forum for the new category.

If the approver 24 accepts the video, but rejects 72 the new category, then the video category association is changed 74 by the approver to a new category. The changed 74 association can be accomplished in a number of different ways. In the preferred embodiment, the category is changed to an already existing category. Therefore, the administrator would select a category from the list of categories and link the video to it.

In an alternate embodiment, the same ability to change the association to an already existing category is available. Additionally though, the administrator can reject the suggested category and create a new category for the video. Therefore, the video will be linked to a newly created category that is different from the one suggested by the user.

Once the video is available for viewing, any one with access to this embodiment is able to view and subsequently rate the video through the watch and rate selector 82. At this point, the video can be downloaded to the viewer's site or viewed online through this embodiment. Once viewed, the viewer is given the option of rating the video in any number of user-defined categories. For example, FIG. 7 details a reality based show based on the premise of the funniest human. Upon viewing the video, the viewer can be presented with a whole series of questions and/or ratings to determine the overall critique of this person's humor. The first question could be the following:

Question 1: Based upon your viewing of the video, how would rate this person's humor?
a. Extremely Humorous
b. Humorous
c. Somewhat Humorous
d. Not Humorous
   Based upon the viewer's opinion, the viewer selects a choice from the above question, which is then recorded and/or tallied by the current invention with all the other inputs received. The results of the ratings are gathered or collected by this embodiment and presents them to the users. The ratings, in this example, are used to determine which one of the uploaded videos contains the funniest human.

An affiliated television network could use the uploaded videos and related ratings to determine the casting for a show or concept or even for determining the winner of a contest. Therefore, the participation, in these shows, is broadened beyond the limited public auditions and the interviews by professional casting directors. As such, general viewership could become more loyal to watching the television show than a present day viewing audience.

This alternate embodiment could also be used for evaluating a prospective audiences' interest in television show concept or pre-promoting a television show online before it is aired or broadcast on television. The benefit of this is that potential audience members can become personally engaged with particular cast members or show themes in the months or weeks leading up to the television show's first broadcast. By gauging the interest before the showing, the television producers or networks can determine the interest level an adjust accordingly.

This alternate embodiment also enables the user of the system to search the central repository 12 in a user-defined manner. For example, the user may search or sort the videos by, but not limited to, highest rated 84, most watched 86, most recent 88, video of the week 90 and contributor of the week 92. The sorted videos can be presented with or without a screen shot for each video included in the sorted categories.

The screen shot in this embodiment, as well in the other embodiments, are automatically generated. The present invention generates the screen shots by randomly selecting shots from the uploaded video. In this embodiment, the approver selects from the screen shots which shot will appear with the listing of the uploaded video in its designated category. With each category, the selected screen is positioned along with the video. Referring to FIG. 7, the highest rated category 84, the number one listing, Leeza'a Old Car, is listed with the related screen shot 94.

Alternate embodiments of the present invention enable the screen shot to be manually generated by the present invention. The shots can be created by the approver manually selecting a specific point in the uploaded video. This screen shot then becomes associated with the video and positioned along side it in the designated category.

The present invention also enables the various existing categories to be automatically generated and presented to an accessor each time the present invention is viewed. (i.e., highest rated 84, most watched 86, most recent 88, video of the week 90 and contributor of the week 92). These category lists dynamically change or are updated as the videos are viewed, rated or uploaded and related tallies are determined. Referring to FIG. 7 as an example, the most watched category 86 is automatically and dynamically generated each time the accessor requests access to the present invention. The videos in this category are listed by the on-going tally to date. Therefore, for the most watched category 86, the top three most watches videos are “Super Rapper,” “Billy Boop” and “Once you were me,” which are based upon the current viewing tally for each of these videos. Another example would be the highest rated category 84 for which the category and its associated ratings are updated each time a viewer views and uploads the video. In FIG. 7, the highest rated video is “Leeza's Old Car,” which is the based upon the most recent tally as determined by the present invention.

In yet another embodiment of the present invention, the present invention is used in conjunction with another form of media such as broadcast radio. For example, radio shows, popular with many individuals, conducts a variety of contests such as to attract or retain listeners. An example of such a contest could be the “Funniest Radio Listener Personality” in which each listener would submit their video to the present invention. Upon submission of the video, it is available to the general public such as the radio listening audience to be viewed and rated. A tally of the ratings is then submitted and used to select the winner of the contest.

Like the previous embodiments, this alternate embodiment permits the video to be uploaded and then placed in the appropriate category. In this embodiment, the primary location (category) would be the “Interactive Radio” followed by the subcategory Radio Show (i.e. Dave & Mike in the Morning, 106.7 FM) and then the sub-subcategory, which in this case would be the name of the contest such as the “Funniest Radio Listener Personality.”

The video is uploaded via the uploader 20 and then placed in the approval queue 22, where it located until it is approved or not. Upon approval of the video, it is placed in the Interactive Radio category and made available to the general public.

The viewing public is able to access the videos under the Interactive Radio category and view and/or rate the videos based upon the content or performance. Upon the rating of the videos, the present invention is able to produce a report that depicts how the videos were rated by the viewers. From this report, the radio station is able to determine a winner.

Similar to the previous embodiments, the display upload video option 54, in the radio media embodiment, also includes a list of categories from which the user can choose to associate the video. In alternate embodiments, there can also be subcategories. If the user is not happy with the categories or the subcategories that are present in the display upload video option 54, then the user may suggest a category or subcategory to the approver 24 or administrator.

In the alternate embodiments, the display upload video option 54 also includes options for a short preview of the video, accompanying text to include a short description of the video, ratings and other information that the user might think is useful or helpful to a potential viewer. Other possible options are contact information of the videographer or uploader and links or guides in order to obtain additional information.

After the display upload video option 54 is completed, the system 10 begins to receive, through the receive function 56, or accept the video from the user. The system 10 stores the video on the central repository 12. The system also stores any accompanying photos on the central repository 12.

Each subcategory and subsubcategory existing in the system 10 includes its own bulletin board, which serves primarily as a discussion forum for viewers of the videos to enter their comments about videos associated with the particular category. This area would be used by potential viewers as a possible means to determine which videos among a particular category to view. The comments posted by previous users would be viewed by the potential viewers in order to aid them in the selection. The comments could also be directed to express a need for a particular type of video within the category.

Videographer discussion boards and personal pages are created when the videographer creates an account as well as for each category, subcategory and sub-subcategories. The discussion board is able to be accessed by viewers and those individuals, accessors, perusing the system 10. The discussion board serves as a forum where any of the viewers of the videographer's videos can enter their comments or remarks about one or more specific videos. For the accessors, it could serve as a basis for possible viewing the works created by the videogrpaher. The comments could be reviewed by the accessor prior viewing the video works to determine if they would be interested in the videogrpaher. While for the viewers, it would most likely serve as a forum to discuss the positives and negatives of the videographer and their works.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A repository for accessing and storing videos, comprising:
a storage device;
a plurality of media categories, wherein a single media category is associated with a video that is located on the storage device;
an uploader configured to permit the video to be transmitted to the storage device; and
a rating system configured to permit rating of the video located on the storage device.

2. The repository as in claim 1, further comprising an approver device configured to either reject or accept the video;

3. The repository as in claim 1, further comprising a browser configured to permit access to the plurality of media categories.

4. The repository as in claim 1, further comprising a remote access configured to permit access to the video on the storage device.

5. The repository as in claim 3, wherein the browser displays the videos with the plurality of media categories.

6. The repository as in claim 5, further comprising a downloader configured to permit the video to be transmitted from the storage device to an alternate location.

7. The repository as in claim 4, further comprising a tracker that indicates the number of times the video was accessed.

8. The repository as in claim 1, further comprising additional data that is associated with the video.

9. The repository as in claim 8, wherein the additional data is selected from the group consisting of photos, text, rating, the category and computer links.

10. The repository as in claim 4, further comprising an account.

11. The repository as in claim 10, wherein the account must be activated in order to access the video on the storage device.

12. The repository as in claim 10, wherein the account must be activated in order to transmit a video through the uploader.

13. The repository as in claim 1, wherein the video is related to a media concept.

14. The repository as in claim 1, further comprising an approver queue linked to the approver device, the approver queue is configured to store the video upon receiving it from the uploader.

15. The repository as in claim 14, wherein the video is moved from the queue upon the approver device rejecting or accepting the video.

16. The repository as in claim 1, wherein the storage device is a database.

17. The repository as in claim 1, wherein the storage device is plurality of databases.

18. The repository as in claim 4, wherein the repository is linked a computer network.

19. The repository as in claim 18, wherein the computer network is selected from the group consisting of a local area network and wide area network.

20. The repository as in claim 18, wherein the computer network is the Internet.

21. The repository as in claim 1, wherein the rating system is configured to determine a winner.

22. The repository as in claim 1, wherein the rating system is configured to select a contestant.

23. The repository as in claim 1, wherein the rating system is configured to determine viewer interest.

24. A method for accessing and storing videos, comprising:
reviewing a video linked to a central repository;
determining whether to accept the video;
associating a category with the video;
in response to accept the video, permitting access to the video;
in response to rejecting the video, restricting access to the video; and
providing a rating system that enables a viewer to provide feedback in regards to the video.

25. The method as in claim 24, further comprising uploading the video to the central repository.

26. The method as in claim 26, searching a plurality of categories, which are associated with a plurality of videos.

27. The method as in claim 24, further comprising accessing the video through a remote access point.

28. The method as in claim 27, wherein the remote access point is linked to a computer network.

29. The method as in claim 27, wherein the computer network is selected from the group consisting of a local area network and a wide area network.

30. The method as in claim 28, wherein the computer network is the Internet.

31. The method as in claim 24, further comprising accessing the central repository through an account.

32. The method as in claim 24, further comprising tracking a number of requests for access to the video.

33. The method as in claim 27, further comprising transmitting the video to another location.

34. A system for accessing and storing videos, comprising:
means for reviewing a video linked to a means for storing;
means for determining whether to accept the video;
means for associating a category with the video;
in response to accept the video, means for permitting access to the video; and
means for rating the video.

35. The system as in claim 34, further comprising means for uploading the video to the means for storing.

36. The system as in claim 34, means for searching a plurality of categories, which are associated with a plurality of videos.

37. The system as in claim 34, further comprising means for accessing the video through a remote access means.

38. The system as in claim 39, wherein the remote access means is linked to a computer network.

39. The system as in claim 37, wherein the computer network is selected from the group consisting of a local area network and a wide area network.

40. The system as in claim 38, wherein the computer network is the Internet.

41. The system as in claim 34, further comprising means for accessing the central repository through an account.

42. The system as in claim 34, further comprising means for tracking a number of requests for access to the video.

43. The system as in claim 37, further comprising transmitting the video to another location.

44. The system as in claim 34, wherein the means for rating is configured to determine a winner.

45. The system as in claim 34, wherein the means for rating is configured to select a contestant.
